(19) United States
(12) Patent Application Publication
(10) Pub. No.: US 2026/0003756 A1
(43) Pub. Date: Jan. 1, 2026

(54) PASSIVE TEMPERATURE INDICATOR FOR A MODULE

(71) Applicant: Dell Products L.P., Round Rock, TX (US)

(72) Inventors: PER HENRIK FREMROT, Novato, CA (US); SHREE RATHINASAMY, Round Rock, TX (US); THOMAS J. DEPARI, North Smithfield, RI (US); GREGORY M. ALLEN, Layton, UT (US)

(21) Appl. No.: 18/758,065

(22) Filed: Jun. 28, 2024

(51) Int. Cl. G06F 11/30; G01K 11/12; H01R 13/66

(52) U.S. Cl. CPC G06F 11/3058; G01K 11/12; H01R 13/6683

(57) ABSTRACT

Devices, systems, and methods for managing a module for use with a chassis are disclosed. The module may include a body, a hardware component, positioned in the body, that consumes power to contribute to computer-implemented services provided by a data processing system housed by the chassis and that generates heat, a connector adapted to operably connect the hardware component to other hardware components of the data processing system, and a passive temperature indicator adapted to visually indicate a thermal state of at least a portion of the body.

### FIELD

Embodiments disclosed herein relate generally to a module for use with a chassis. More particularly, embodiments disclosed herein relate to systems and methods to manage use of modules using passive temperature indicators.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show diagrams illustrating a system in accordance with an embodiment.

FIGS. 2A-2B show diagrams illustrating a module in accordance with an embodiment.

FIGS. 2C-2I show side view diagrams illustrating a passive temperature indicator in accordance with an embodiment.

FIG. 3 shows a flow diagram illustrating a method of managing use of modules in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a module for use with a chassis. The module may be used to provide computer-implemented services. The computer-implemented services may include any quantity and type of such services.

To provide a desired type and/or quantity of the computer-implemented services, the module may include any number and/or type of hardware components which consume power and generate heat. For example, the module may be an optical transceiver module, which may include an optoelectronic device. The optoelectronic device may be used to convert optical signals to electrical signals, and in doing so may consume power and generate heat as a byproduct. The heat generated by the optoelectronic device may result in an increase in temperature of the body of the optical transceiver module.

While providing the computer-implemented services, the optical transceiver module may require service by a technician (e.g., to modify and/or repair the module, to replace the module). To service the optical transceiver module, the technician may come into physical contact with at least a portion of the body of the module. However, due to the heat generated during operation, the portion of the body may exceed a safe handling temperature.

To increase a likelihood that the optical transceiver module is handled in a safe manner, the optical transceiver module may include a passive temperature indicator adapted to visually indicate a thermal state of at least a portion of the body. The passive temperature indicator may include a thermochromic layer, which may be adapted to change color based on a critical temperature. The critical temperature may be based on a safe handling temperature for the module.

The passive temperature indicator may also include a plurality of thermochromic layers. For example, the position of the hardware component within the module may result in a non-uniform temperature distribution across the body. Multiple thermochromic layers with different critical temperatures may be positioned on the module to indicate whether a particular portion of the body is above a threshold temperature. For example, a first thermochromic layer positioned further from the hardware component may have a lower critical temperature than a second thermochromic layer positioned near the hardware component. In doing so, both thermochromic layers may be used to determine whether a portion of the body exceeds a safe handling temperature.

Thus, embodiments disclosed herein may address, among other technical problems, the technical challenge of determining whether a module is at a safe handling temperature. Using a passive temperature indicator, the thermal state of at least a portion of the body of the module may be determined by visual inspection of the module without consuming additional power. By doing so, the likelihood of safely handling the module may be improved, which may reduce the likelihood of physical injury to a person and/or damage to the module during handling.

In an embodiment, a module for use with a chassis is disclosed. The module may include: a body; a hardware component, positioned in the body, that consumes power to contribute to computer implemented services provided by a data processing system housed by the chassis and that generates heat; a connector adapted to operably connect the hardware component to other hardware components of the data processing system; and a passive temperature indicator adapted to visually indicate a thermal state of at least a portion of the body.

The body may be adapted to allow the module to be removed from the chassis.

The hardware component may be thermally coupled to the body.

The heat generated by the hardware component may generate a non-uniform temperature distribution across the body.

The passive temperature indicator may include at least one thermochromic layer that is in thermal conduction communication with a portion of the body, the thermochromic layer being adapted to change color based on a critical temperature.

The critical temperature of the at least one thermochromic layer may be based at least in part on a safe handling temperature.

The critical temperature may be further based, at least in part, on an expected non-uniform temperature distribution across the body, and a position of the passive temperature indicator on the body.

The thermochromic layer may be of a size that allows the thermal state to be identifiable from visual inspection of the thermochromic layer, and that facilitates thermal dissipation by the body.

The passive temperature indicator may also include: a plurality of thermochromic layers including the at least one thermochromic layer, at least two of the plurality of the thermochromic layers have different critical temperatures, and the at least two of the plurality of the thermochromic layers are positioned on different portions of the body.

The positions of the at least two of the plurality of the thermochromic layers may be based on an expected non-uniform temperature distribution across the body.

The different critical temperatures may be adapted to indicate whether a particular portion of the body is above a threshold temperature.

The module may also include a signal connector usable to transmit and receive signals by the data processing system with respect to other data processing systems.

In an embodiment, a data processing system is provided that may include a chassis and a module for use with the chassis.

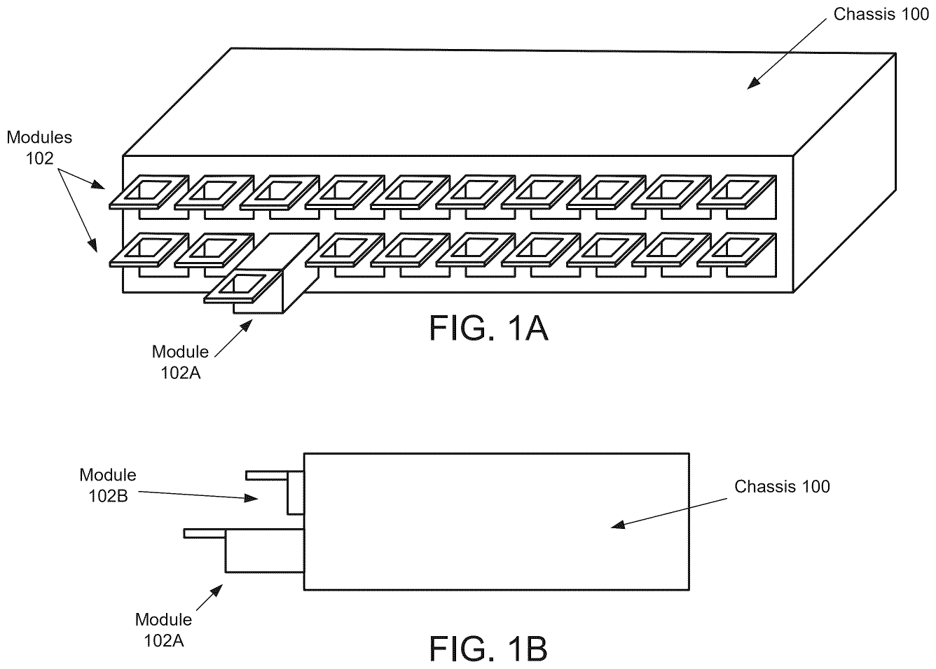

Turning to FIG. 1A, a diagram illustrating a system in accordance with an embodiment is shown. The system shown in FIG. 1A may provide computer-implemented services using a data processing system (not shown). The computer-implemented services may include, for example, database services, instant messaging services, and/or other types of computer-implemented services. To provide the computer-implemented services, the system may include chassis 100. Chassis 100 may be a physical device for housing components of the data processing system such as modules 102.

Chassis 100 may house any number and/or type of modules 102 which may vary in performance, functionality, and/or other characteristics. For example, chassis 100 may house transceiver modules (e.g., optical transceivers, radio transceivers, Ethernet transceivers), which may be used to transmit and receive data as part of providing the computer-implemented services.

For example, chassis 100 may house module 102A. Module 102A may be an optical transceiver module, which may be operably connected to chassis 100 via an electrical interface, and may transmit and receive optical signals via a fiber optic interface. Module 102A may also include a handle and a body. While providing the computer-implemented services, module 102A may generate heat (e.g., as a byproduct), which may result in an increase in temperature of the body of module 102A over time.

During operation, module 102A may require service by a technician. Module 102A may require service to (i) make repairs and/or modifications to module 102A, (ii) replace module 102A with a different module and/or other device, and/or (iii) to perform other tasks to provide the computer-implemented services. In order to service module 102A, the technician may use the handle to remove module 102A from chassis 100, and may also come into physical contact with other portions of the body of module 102A.

However, due to heat generation during operation, the body of module 102A may exceed a safe handling temperature. Due to the size and/or shape restrictions of chassis 100, it may be difficult to add additional heat dissipation features (e.g., a heat sink) to the body of module 102A to prevent module 102A from exceeding the safe handling temperature.

Additionally, it may be difficult to determine whether the temperature of the body of module 102A exceeds the safe handling temperature due to the position of the body within chassis 100 (e.g., temperature indicators may be unable to read the temperature of the portion of module 102A inside of chassis 100), and/or temperature indicators may require power input (e.g., digital thermometers), resulting in increased power consumption and/or the temperature indicators becoming inoperable while unpowered.

Consequently, physical contact with the body of module 102A may result in (i) injury to the technician (e.g., burns and/or other physical injury), (ii) violations of safety protocols instituted by authoritative entities (e.g., Network Equipment-Building System (NEBS) regulations), (iii) damage to module 102A (e.g., due to dropping and/or throwing module 102A in response to contact with the hot surface), and/or (iv) other undesirable outcomes. The inability to safely service module 102A may result in delays and/or disruptions to the computer-implemented services provided using module 102A.

In general, embodiments disclosed herein may provide methods, systems, and/or devices for improving the likelihood that modules are handled safely. To do so, passive temperature indicators may be applied to the body of the modules in order to visually indicate a thermal state of at least a portion of the body, which may allow for a person to determine whether the module exceeds a safe handling temperature threshold. The passive temperature indicators may include thermochromic layers applied to portions of the body which exhibit a change in color at a critical temperature. The thermochromic layers may change color without power input and may be applied in a manner which does not significantly alter the size and/or shape of the module (e.g., without impacting the ability of the module to be inserted into the chassis). The critical temperature may be based at least in part on a safe handling temperature of the module.

The passive temperature indicators may be positioned on the body based on an expected non-uniform temperature distribution. For example, a heat generation element of a module may be positioned within the body of the module near the edge connector (e.g., the connector which connects the module to the chassis which is not visible while the module is fully inserted into the chassis). A thermochromic layer may be applied by the edge connector which has a critical temperature close to a safe handling temperature threshold. A second thermochromic layer may also be applied on a portion of the body visible while the module is fully inserted into the chassis so that it may be determined whether the module is safe to handle prior to removing the module from the chassis. The second thermochromic layer may have a critical temperature below that of the safe handling temperature threshold, which may be determined based on a theoretical temperature gradient (e.g., the expected temperature at the portion of body if the non-visible portion of the body exceeds the safe handling temperature threshold).

By doing so, it may be determined whether a module positioned in a chassis exceeds a safe handling temperature threshold upon visual inspection of the module without requiring power input and/or impacting the ability of the module to be inserted into the chassis. Therefore, it may be more likely that the module may be serviced in a manner which meets safety regulations, which may reduce a likelihood that the computer-implemented services provided using the module are interrupted and/or delayed.

To provide the above-noted functionality, the system of FIG. 1A may include chassis 100 and/or modules 102. Chassis 100, modules 102, and/or any other type of devices not shown in FIG. 1A may perform all, or a portion of the computer-implemented services independently and/or cooperatively. Each of these components is discussed below.

Chassis 100 may be a physical device for housing components such as computing devices. The computing devices may include one or more components. The components may include, for example, device stacks that vary in size and number of devices in each device stack, with any of the devices in any of the device stacks varying in performance, functionality, and/or other characteristics.

One or more device stacks may include any number of modules 102. Modules 102 may include (i) transceiver modules (e.g., optical transceivers, radio transceivers, Ethernet transceivers), (ii) memory modules (e.g., random access memory (RAM)), (iii) processing devices (e.g., central processing units, graphics processing units), (iv) storage devices (e.g., hard disk drives, solid state drives), and/or (v) other types of modules.

While illustrated in FIG. 1A with a limited number of specific components, a system may include additional, fewer, and/or different components without departing from embodiments disclosed herein.

Turning to FIG. 1B, a side view diagram illustrating a system in accordance with an embodiment is shown. As discussed in the description of FIG. 1A, the system may include chassis 100 which may house any number of modules (e.g., module 102B).

Module 102B may depict a module fully inserted into chassis 100. In the fully inserted position, a portion of the body of module 102B may be positioned in the interior of chassis 100 (e.g., the interior body portion) and may not be visible to a person (e.g., a technician responsible for servicing the modules). A second portion of the body and the handle of module 102B may protrude from chassis 100 and may be visible to a person.

Module 102A may depict a module partially removed from chassis 100. Module 102A may be removed from chassis 100, for example, by the technician during servicing of module 102A. Module 102A may be removed using the handle, which may expose all and/or a portion of the interior body portion of module 102A. As a result, the technician may come into physical contact with the interior body portion.

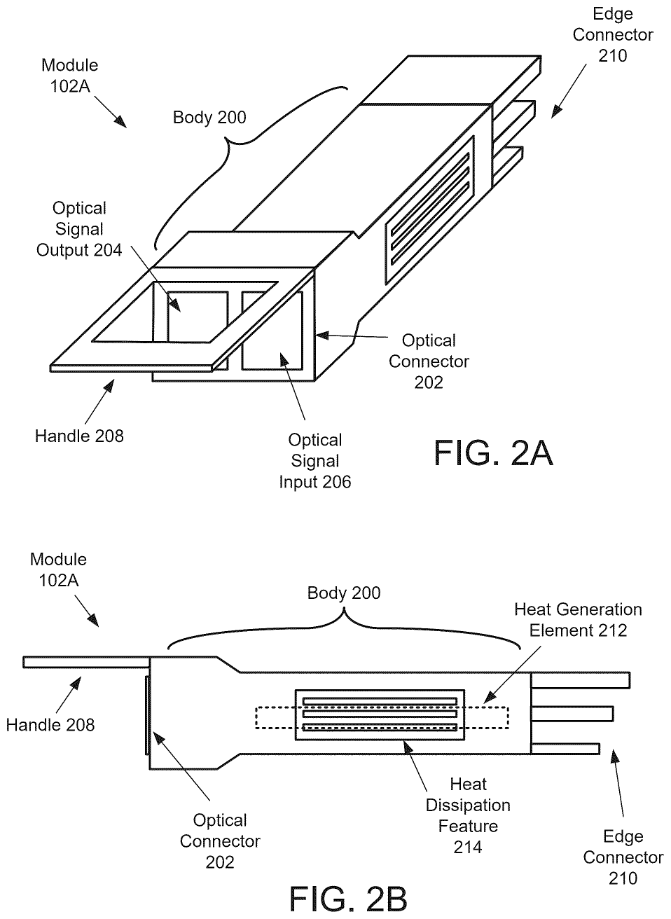

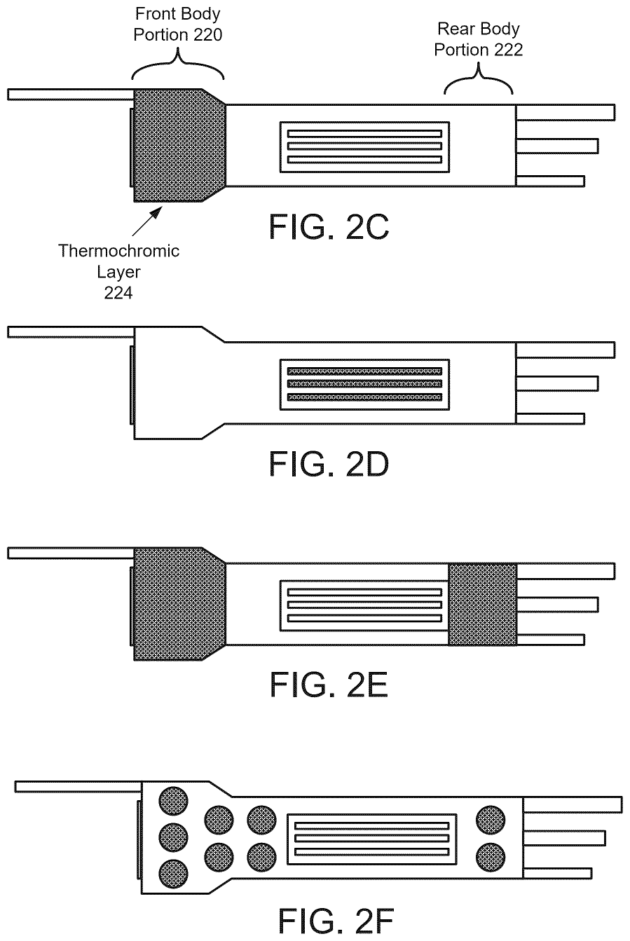

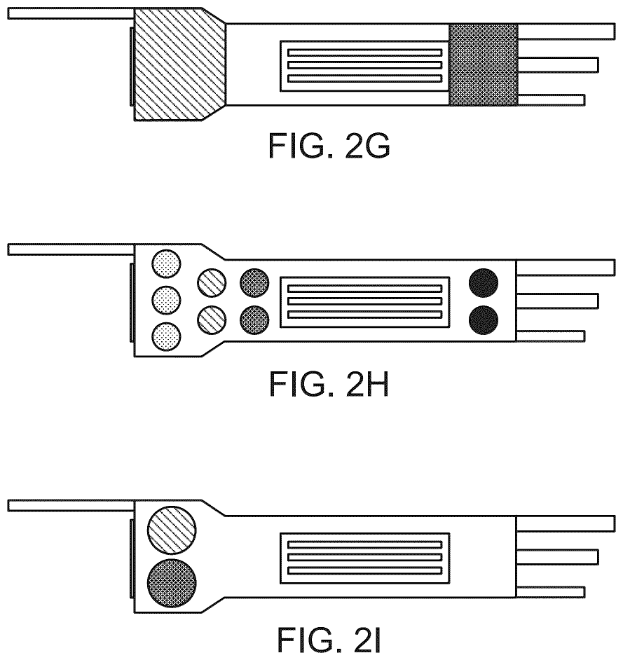

Turning to FIG. 2A, a diagram of module 102A in accordance with an embodiment is shown. Module 102A may be a transceiver (e.g., an optical transceiver), which may be used by a data processing system to communicate data with other devices. To communicate data with other devices, module 102A may include body 200, optical connector 202, optical signal output 204, optical signal input 206, handle 208, and edge connector 210. Each of these portions of module 102A is discussed below.

Module 102A may include a body (e.g., body 200). Body 200 may include a hollow metal casing used to house various hardware components of module 102A. For example, body 200 may house a hardware component that consumes power to contribute to computer-implemented services provided by the data processing system housed by chassis 100 and that generates heat. Refer to FIG. 2B for additional details regarding the hardware component.

Body 200 may be adapted to allow module 102A to be removed from chassis 100 without disassembling chassis 100. For example, body 200 may be of a size, shape, and/or include other characteristics which allows for module 102A to be inserted into and/or removed from chassis 100 without modifying chassis 100.

While described with respect to module 102A being an optical transceiver adapted to allow module 102A to be removed from chassis 100 without disassembling chassis 100, it will be appreciated that other types of modules (e.g., memory modules, processing devices such as graphics processing units, storage devices) may be positioned with respect to chassis 100 in a manner which requires modification of the chassis (e.g., opening of a compartment door of the chassis) without departing from embodiments disclosed herein.

Module 102A may include a connector adapted to operably connect the hardware component to other hardware components of the data processing system (e.g., edge connector 210). Edge connector 210 may include an electrical interface used to transmit and receive electrical signals.

Module 102A may also include a signal connector usable to transmit and receive signals by the data processing system with respect to other data processing systems (e.g., optical connector 202). Optical connector 202 may transmit and receive optical signals via optical signal output 204 and optical signal input 206, respectively. Optical signal output 204 and optical signal input 206 may be used to communicate optical signals via a fiber optic cable.

To remove and/or insert module 102A into chassis 100, module 102A may include handle 208. Handle 208 may protrude from body 200, which may facilitate handling of module 102A (e.g., in order to service and/or replace module 102A).

Turning to FIG. 2B, a side view diagram of module 102A in accordance with an embodiment is shown. In addition to the components discussed in the description of FIG. 2A, module 102A may also include heat generation element 212 and heat dissipation feature 214. Each of these portions of module 102A is discussed below.

As discussed above, body 200 may house a hardware component that consumes power and generates heat (e.g., heat generation element 212, shown in dashing to indicate heat generation element 212 is positioned in the interior of body 200). Heat generation element 212 may include any number and/or type of hardware components which generate heat during their operation. For example, heat generation element 212 may include optoelectronic devices (e.g., transmit optical sub-assembly (TOSA), receiver optical sub-assembly (ROSA)) responsible for converting electrical signals into optical signals and vice versa. While performing their functionality, heat may be generated as a byproduct.

Heat generation element 212 may be thermally coupled to body 200. For example, body 200 may include a conductive material (e.g., a metal casing) which may be in physical contact with heat generation element 212. As a result, heat generated by heat generation element 212 may be transferred to body 200 (e.g., via thermal conduction), resulting in an increase in temperature of body 200.

Heat generation element 212 may generate a non-uniform temperature distribution across body 200. For example, module 102A may include an optoelectronic device positioned near edge connector 210 in the interior of body 200. As a result, the outer portion of body 200 near edge connector 210 (e.g., the portion closest to the optoelectronic device) may be at a higher temperature than the outer portion of body 200 near optical connector 202 (e.g., the portion furthest from the optoelectronic device). The non-uniform temperature distribution may result in a temperature gradient across body 200.

In order to dissipate heat generated by heat generation element 212, module 102A may include heat dissipation feature 214. Heat dissipation feature 214 may include any number and/or type of heat dissipation features, including (i) heat sinks, (ii) heat spreaders, (iii) vents, and/or (iv) other heat dissipation features. Heat dissipation feature 214 may be restricted in size, shape, thickness, and/or other characteristics in order to allow module 102A to fit into chassis 100. Due to the restrictions, heat dissipation feature 214 may be unable to prevent body 200 from increasing in temperature during operation of module 102A.

While described with respect to a module which includes a heat dissipation feature (e.g., heat dissipation feature 214) positioned on the side portion of the body, it will be appreciated that the heat dissipation feature may be present on other portions of the module (e.g., the top portion) without departing from embodiments disclosed herein. Additionally, it will be appreciated that the module may not include a heat dissipation feature without departing from embodiments disclosed herein.

Thus, as shown in FIGS. 2A-2B, a module in accordance with an embodiment may be used by a data processing system to communicate data with other data processing systems. To communicate data, the module may include a hardware component that consumes power and generates heat, which may result in the body of the module increasing in temperature. Based on the position of the hardware component, the generation of heat may result in a non-uniform temperature distribution across the body.

To further clarify embodiments disclosed herein, side view diagrams illustrating a passive temperature indicator on a module in accordance with an embodiment are shown in FIGS. 2C-2I. The module may be similar to module 102A. In these diagrams, portions of the module are filled with a patterned infill to represent areas covered by thermochromic layers. Different patterns of infill represent thermochromic layers with different critical temperatures.

The passive temperature indicator may be adapted to visually indicate a thermal state of at least a portion of the body. The passive temperature indicator may include at least one thermochromic layer that is in thermal conduction communication with a portion of the body, the thermochromic layer being adapted to change color based on a critical temperature. For example, the thermochromic layer may exhibit a first color when the portion of the body is below the critical temperature (and/or may be colorless), and the thermochromic layer may exhibit a second color when the portion of the body is at or above the critical temperature. Thermal conduction communication may include the thermochromic layer being in physical contact with the portion of the body, which may allow heat transfer between the thermochromic layer and the portion of the body.

The thermochromic layer may include (i) thermochromic paint, (ii) thermochromic ink, and/or (iii) other types of thermochromic layers. The thermochromic layers may be adapted to change color based on a critical temperature using a thermochromic material including (i) liquid crystals, (ii) leuco dyes, and/or (iii) other types of thermochromic materials.

The thermochromic layer may be applied to the portion of the body via (i) spraying as an aerosol, (ii) applying with a brush, (iii) applying with a roller, (iv) screen printing, (v) pad printing, (vi) flexographic printing, (vii) applying as a label (e.g., the thermochromic layer embedded in the label with a pressure sensitive adhesive), and/or (viii) other methods of application.

Turning to FIG. 2C, a first side view diagram illustrating a passive temperature indicator in accordance with an embodiment is shown. The first side view diagram may illustrate a passive temperature indicator including a thermochromic layer (e.g., thermochromic layer 224) applied on a portion of the body of the module near the optical connector (e.g., front body portion 220). Thermochromic layer 224 is illustrated as a black infill with white crosshatch.

The critical temperature of thermochromic layer 224 may be based at least in part on a safe handling temperature. For example, based on safety requirements provided by an authoritative entity, it may be determined that the module should not be handled if the body exceeds a temperature of 60° C. A thermochromic layer may then be selected and applied to front body portion 220 which has a critical temperature of 60° C. Alternatively, a thermochromic layer may be selected which has a slightly lower critical temperature (e.g., 55° C.) as a further precaution to ensure the module is handled safely.

The critical temperature may be further based, at least in part, on an expected non-uniform temperature distribution across the body, and a position of the passive temperature indicator on the body. For example, thermochromic layer 224 may be applied to front body portion 220 because the portion is visible to a person when the module is fully inserted into the chassis. However, the heat generation element of the module may be positioned in the interior of the body near the edge connector (e.g., rear body portion 222). In order to use thermochromic layer 224 applied to front body portion 220 to determine whether rear body portion 222 exceeds a safe handling temperature, an expected non-uniform temperature distribution may be determined.

To determine the expected non-uniform temperature distribution, the temperature of front body portion 220 may be measured when the temperature of rear body portion 222 meets a safe handling temperature threshold. For example, the safe handling temperature threshold may be determined to be 60° C. When the temperature of rear body portion 222 reaches 60° C., the temperature of front body portion 220 may be 40° C. A thermochromic layer may then be selected which has a critical temperature of 40° C. and applied to front body portion 220. In doing so, the passive temperature indicator may be calibrated to reflect an expected temperature gradient across the body of the module.

Turning to FIG. 2D, a second side view diagram illustrating a passive temperature indicator in accordance with an embodiment is shown. The second side view diagram may illustrate a passive temperature indicator including a thermochromic layer applied in thin strips on a body portion of the module. The thermochromic layer is illustrated as a black infill with white crosshatch.

Heat generated during operation of the module may be at least partially dissipated through the body of the module, which may reduce the temperature of the module and thus reduce a likelihood of damage to the module caused by overheating. However, the addition of a coating, layer, and/or other material to the body of the module may reduce the efficiency and/or ability of the body to dissipate heat.

To limit the impact of the addition of a thermochromic layer to the body on the efficiency of thermal dissipation, the thermochromic layer may be of a size that allows the thermal state to be identifiable from visual inspection of the thermochromic layer, and that facilitates thermal dissipation by the body.

For example, the thermochromic layer may be applied to the body of the module in thin strips. By doing so, a person may be able to identify whether the module exceeds a safe handling temperature threshold based on the color of the thin strips, while reducing the amount of surface area of the body covered by the thermochromic layer. Reducing the amount of surface area covered by the thermochromic layer may limit the impact on the efficiency of thermal dissipation by the body.

Turning to FIG. 2E, a third side view diagram illustrating a passive temperature indicator in accordance with an embodiment is shown. The third side view diagram may illustrate a passive temperature indicator including a thermochromic layer applied to two portions of the body of the module (e.g., front body portion 220 and rear body portion 222). The thermochromic layer is illustrated as a black infill with white crosshatch.

Application of the thermochromic layer to multiple portions of the body of the module may provide a visual indication of the thermal state of each of the portions. For example, a heat generation element may be located on the interior of rear body portion 222, resulting in a non-uniform temperature distribution across the body (e.g., rear body portion 222 may be at a higher temperature than front body portion 220). In order to determine which portions of the body exceed a safe handling temperature, a thermochromic layer may be applied to front body portion 220 and rear body portion 222. In doing so, a person may be able to visually identify whether either portion of the body is safe to handle.

Turning to FIG. 2F, a fourth side view diagram illustrating a passive temperature indicator in accordance with an embodiment is shown. The fourth side view diagram may illustrate a passive temperature indicator including a thermochromic layer applied in circles along the body of the module. The thermochromic layer is illustrated as a black infill with white crosshatch.

As discussed in the description of FIG. 2E, application of a thermochromic layer to multiple portions of the body may allow for a thermal state of each of the portions to be determined. The thermochromic layer may be applied in any shape, size, and/or quantity along the body (e.g., small circles distributed along the length of the body) to be used to determine whether any and/or all portions of the body exceed a safe handling temperature threshold.

Turning to FIG. 2G, a fifth side view diagram illustrating a passive temperature indicator in accordance with an embodiment is shown. The fifth side view diagram may illustrate a passive temperature indicator including a first thermochromic layer and a second thermochromic layer applied to rear body portion 222 and front body portion 220, respectively. The first thermochromic layer is illustrated as a black infill with white crosshatch, and the second thermochromic layer is illustrated as black diagonal lines with white infill.

The passive temperature indicator may include a plurality of thermochromic layers, which may have different critical temperatures and may be positioned on different portions of the body. The positions of the thermochromic layers may be based on an expected non-uniform temperature distribution across the body. For example, the heat generation element of the module may be positioned in the interior of the body near the edge connector (e.g., near rear body portion 222). A safe handling temperature threshold for the module may be determined to be 60° C. In order to visually identify whether rear body portion 222 exceeds the safe handling temperature threshold, a first thermochromic layer may be applied to rear body portion 222 which has a critical temperature of 60° C.

Because the first thermochromic layer on rear body portion 222 may be obscured when the module is fully inserted into the chassis, a second thermochromic layer may be applied to front body portion 220 (e.g., the portion of the body which protrudes from the chassis when the module is fully inserted). An expected temperature gradient may be determined based on a non-uniform temperature distribution, which may indicate that when rear body portion 222 meets the safe handling temperature threshold (e.g., 60° C.), front body portion 220 may be 45° C. The second thermochromic layer may be selected which has a critical temperature of 45° C.

Thus, a plurality of thermochromic layers with different critical temperatures may be used to determine whether the module is safe to handle upon visual inspection of the module. The different critical temperatures may be adapted to indicate whether a particular portion of the body (e.g., rear body portion 222) is above a threshold temperature.

Turning to FIG. 2H, a sixth side view diagram illustrating a passive temperature indicator in accordance with an embodiment is shown. The sixth side view diagram may illustrate a passive temperature indicator including four thermochromic layers with different critical temperatures distributed along the body of the module. The thermochromic layers are represented as circles and each infill pattern illustrates a thermochromic layer with a different critical temperature.

As discussed in the description of FIG. 2G, a non-uniform temperature distribution may result in a temperature gradient along the body of the module. In order to determine whether multiple portions of the body are safe to handle, any number, shape, and/or type of thermochromic layers with different critical temperatures may be selected and applied along the body to indicate whether a particular portion and/or portions of the body exceed a safe handling temperature threshold.

Turning to FIG. 2I, a seventh side view diagram illustrating a passive temperature indicator in accordance with an embodiment is shown. The seventh side view diagram may illustrate a passive temperature indicator including a first thermochromic layer and a second thermochromic layer applied to front body portion 220. The first thermochromic layer is illustrated as a black infill with white crosshatch, and the second thermochromic layer is illustrated as black diagonal lines with white infill.

Thermochromic layers with different critical temperatures may be applied to the same portion of the body of the module in order to visually indicate whether the portion of the body exceeds a safe handling temperature threshold and whether a second portion of the body exceeds a safe handling temperature threshold. For example, the heat generation element of the module may be positioned in the interior of the body near the edge connector (e.g., near rear body portion 222). A safe handling temperature threshold for the module may be determined to be 60° C.

For a person who wishes to handle the module (e.g., a technician), it may be advantageous to know whether different portions of the body (e.g., front body portion 220, rear body portion 222) exceed the safe handling temperature threshold prior to removing the module from the chassis. To do so, two thermochromic layers with different critical temperatures may be applied to front body portion 220 (e.g., the portion of the body which protrudes from the chassis when the module is fully inserted). The first thermochromic layer may have a critical temperature of 60° C., which may be used to determine whether front body portion 220 is safe to handle. The second thermochromic layer may have a critical temperature of 50° C., which may be selected based on an expected non-uniform temperature distribution and usable to determine whether rear body portion 222 is safe to handle.

Thus, a plurality of thermochromic layers with different critical temperatures may be applied to the same portion of the body (e.g., front body portion 220), and used to determine whether different portions of the body exceed a safe handling temperature threshold.

While described in FIGS. 2C-2I with respect to the thermochromic layers being in specific positions, it will be appreciated that any position, arrangement, shape, number, type, color, and/or combination of thermochromic layers may be included in the passive temperature indicator without departing from embodiments disclosed herein. For example, a thermochromic layer may be applied in a manner which results in a warning symbol or word (e.g., hot, caution) being displayed at the critical temperature.

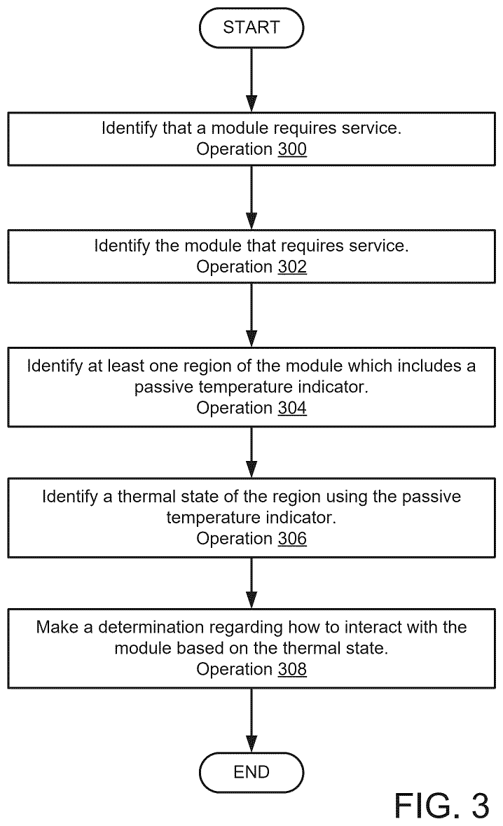

Turning to FIG. 3, a flow diagram illustrating a method of managing use of modules in accordance with an embodiment is shown. In the diagram discussed below and shown in this figure, any of the operations may be repeated, performed in different orders, omitted, and/or performed in parallel and/or a partially overlapping in time manner with other operations.

At operation 300, it may be identified that a module requires service. Identifying that a module requires service may include (i) receiving a notification (e.g., via a message over a communication system, via user input to a graphical user interface) that a module requires service, (ii) reading a notification that a module requires service from storage, and/or (iii) other methods.

At operation 302, the module that requires service may be identified. Identifying the module that requires service may include (i) parsing the notification to ascertain which module requires service, (ii) identifying the chassis which houses the module that requires service, (iii) locating the module within the chassis, and/or (iv) other methods.

At operation 304, at least one region of the module may be identified which includes a passive temperature indicator. Identifying the region may include (i) visually inspecting the portion of the module protruding from the chassis to identify a thermochromic layer, (ii) removing the module from the chassis by the handle until a thermochromic layer is visible, and/or (iii) other methods.

At operation 306, a thermal state of the region may be identified using the passive temperature indicator. Identifying the thermal state may include (i) determining the color of a thermochromic layer of the passive temperature indicator, (ii) determining, based on the color of the thermochromic layer, whether the thermochromic layer is at or above the critical temperature, and/or (iii) other methods.

At operation 308, a determination may be made regarding how to interact with the module based on the thermal state. Making the determination may include (i) identifying, based on whether the thermochromic layer is at or above the critical temperature, whether a portion of the module exceeds a safe handling temperature, (ii) determining, based on whether the portion exceeds the safe handling temperature, whether the portion is safe to handle, (iii) handling the portion if it is determined that the portion is safe to handle, (iv) waiting to handle the portion if it is determined that the portion is not safe to handle, and/or (v) other methods.

The method may end following operation 308.

Therefore, the method described in FIG. 3 may be used to determine whether a module is safe to handle using a passive temperature indicator. Using the passive temperature indicator may include identifying the thermal state of the module based on the color of at least one thermochromic layer. By doing so, a person who wishes to handle the module may be less likely to be injured and/or damage the module by visually identifying whether the module exceeds a safe handling temperature threshold prior to handling the module.

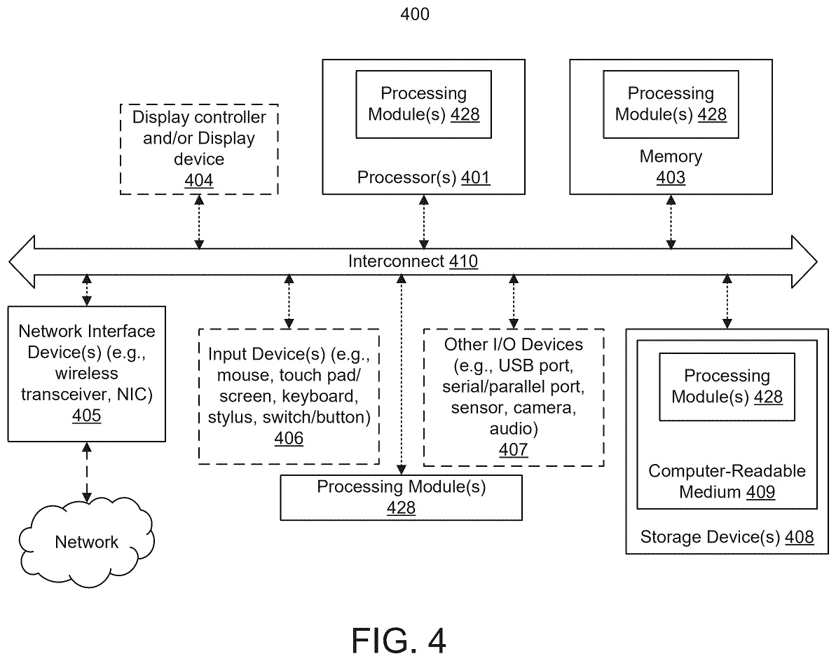

Any of the components illustrated in FIGS. 1A-2I may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A module for use with a chassis, comprising:
a body;
a hardware component, positioned in the body, that consumes power to contribute to computer-implemented services provided by a data processing system housed by the chassis and that generates heat;
a connector adapted to operably connect the hardware component to other hardware components of the data processing system; and
a passive temperature indicator adapted to visually indicate a thermal state of at least a portion of the body.

2. The module of claim 1, wherein the body is adapted to allow the module to be removed from the chassis.

3. The module of claim 1, wherein the hardware component is thermally coupled to the body.

4. The module of claim 3, wherein the heat generated by the hardware component generates a non-uniform temperature distribution across the body.

5. The module of claim 1, wherein the passive temperature indicator comprises at least one thermochromic layer that is in thermal conduction communication with a portion of the body, the thermochromic layer being adapted to change color based on a critical temperature.

6. The module of claim 5, wherein the critical temperature of the at least one thermochromic layer is based at least in part on a safe handling temperature.

7. The module of claim 6, wherein the critical temperature is further based, at least in part, on an expected non-uniform temperature distribution across the body, and a position of the passive temperature indicator on the body.

8. The module of claim 5, wherein the thermochromic layer is of a size that allows the thermal state to be identifiable from visual inspection of the thermochromic layer, and that facilitates thermal dissipation by the body.

9. The module of claim 5, wherein the passive temperature indicator further comprises:
a plurality of thermochromic layers comprising the at least one thermochromic layer, at least two of the plurality of the thermochromic layers have different critical temperatures, and the at least two of the plurality of the thermochromic layers are positioned on different portions of the body.

10. The module of claim 9, wherein the positions of the at least two of the plurality of the thermochromic layers are based on an expected non-uniform temperature distribution across the body.

11. The module of claim 10, wherein the different critical temperatures are adapted to indicate whether a particular portion of the body is above a threshold temperature.

12. The module of claim 1, wherein the module further comprises a signal connector usable to transmit and receive signals by the data processing system with respect to other data processing systems.

13. A data processing system, comprising:
a chassis; and
a module for use with the chassis, the module comprising:
a body;
a hardware component, positioned in the body, that consumes power to contribute to computer-implemented services provided by the data processing system housed by the chassis and that generates heat;
a connector adapted to operably connect the hardware component to other hardware components of the data processing system; and
a passive temperature indicator adapted to visually indicate a thermal state of at least a portion of the body.

14. The data processing system of claim 13, wherein the body is adapted to allow the module to be removed from the chassis.

15. The data processing system of claim 13, wherein the hardware component is thermally coupled to the body.

16. The data processing system of claim 15, wherein the heat generated by the hardware component generates a non-uniform temperature distribution across the body.

17. The data processing system of claim 13, wherein the passive temperature indicator comprises at least one thermochromic layer that is in thermal conduction communication with a portion of the body, the thermochromic layer being adapted to change color based on a critical temperature.

18. The data processing system of claim 17, wherein the critical temperature of the at least one thermochromic layer is based at least in part on a safe handling temperature.

19. The data processing system of claim 18, wherein the critical temperature is further based, at least in part, on an expected non-uniform temperature distribution across the body, and a position of the passive temperature indicator on the body.

20. The data processing system of claim 17, wherein the thermochromic layer is of a size that allows the thermal state to be identifiable from visual inspection of the thermochromic layer, and that facilitates thermal dissipation by the body.
